(19) United States
(12) Patent Application Publication
(10) Pub. No.: US 2017/0228137 A1
(43) Pub. Date: Aug. 10, 2017

(54) LOCAL ZOOMING OF A WORKSPACE ASSET IN A DIGITAL COLLABORATION ENVIRONMENT

(71) Applicant: Prysm, Inc., San Jose, CA (US)

(72) Inventors: Dino C. Carlos, Fischers, IN (US); Adam P. Cuzzort, Westfield, IN (US)

(21) Appl. No.: 15/422,398

(22) Filed: Feb. 1, 2017

Related U.S. Application Data
(60) Provisional application No. 62/292,180, filed on Feb. 5, 2016.

(51) Int. Cl. G06F 3/0484; G06T 11/60; G06T 3/40; G06F 3/14

(52) U.S. Cl. CPC G06F 3/04845; G06F 3/1423; G06T 11/60; G06T 3/40; G06T 2200/24; H04L 67/42

(57) ABSTRACT

Content is displayed during a collaboration session by causing an asset to be displayed on a first display at a first size and at a first aspect ratio, while the asset is displayed on a second display at a second size and at the first aspect ratio, receiving a first display input via the first display indicating a mode change for displaying the asset, and, in response to receiving the first display input, causing an image of at least a portion of the asset to be displayed on the first display at a third size that is larger than the first size, while the asset continues to be displayed on the second display at the second size and at the first aspect ratio.

### CROSS-REFERENCE TO RELATED APPLICATIONS

This application claims benefit of U.S. Provisional Patent Application filed Feb. 5, 2016 and having Ser. No. 62/292,180. The subject matter of this related application is hereby incorporated herein by reference.

### BACKGROUND OF THE INVENTION

Field of the Invention

Embodiments of the present invention relate generally to video conferencing and collaboration systems and, more specifically, to local zooming of a workspace asset in a digital collaboration environment.

Description of the Related Art

Large multi-touch display walls combine the intuitive interactive capabilities of touch-screen technology with the immersive display features of large screens. Large multi-touch display walls also allow presenters to display a multitude of visual and audio-visual assets, such as images, videos, documents, and presentation slides, and also interact with these assets by touching them. Touch or gesture-based interactions may include dragging assets to reposition them on the screen, tapping assets to display or select menu options, swiping assets to page through documents, or using pinch gestures to resize assets. Via such interactions, multi-touch display walls facilitate more flexible and emphatic presentations of various materials to audiences, for example by annotating written or image content in an asset, starting and stopping a video in an asset, etc.

In addition to enabling content-rich presentations, such display walls can facilitate communication and collaborative work between remotely located parties. For example, when two remotely located collaboration venues are each equipped with a multi-touch display wall, collaboration between the two venues can be conducted in real-time, thereby leveraging the input and creativity of multiple parties, regardless of location. Furthermore, with suitable software, mobile devices such as smartphone and electronic tablets can now be employed as reduced-size touch displays. Thus, mobile computing can be incorporated into collaboration systems, so that users are not limited to performing collaborative work in facilities equipped with multi-touch display walls.

One drawback to employing a mobile computing device for collaborative work between different locations presents itself when the size and/or aspect ratio of the mobile computing device that is associated with one collaboration location differs significantly from the size and/or aspect ratio of the display device associated with another collaboration location. For example, when a first collaboration location has a relatively large display, such as a display wall, and a user at the first collaboration location scales a visual asset to a smaller size, the asset may still be readable on the larger display. However, when the display device associated with a second collaboration location is a relatively smaller display device, such as an electronic tablet or smart phone, the reduced size asset may be unreadably small.

As the foregoing illustrates, what is needed are more effective techniques for displaying visual content during collaboration sessions involving display devices having different sizes and aspect ratios.

### SUMMARY OF THE INVENTION

One embodiment of the present invention sets forth a computer-implemented method for displaying content during a collaboration session, the method comprising causing an asset to be displayed on a first display at a first size and at a first aspect ratio, while the asset is displayed on a second display at a second size and at the first aspect ratio, receiving a first display input via the first display indicating a mode change for displaying the asset, and, in response to receiving the first display input, causing an image of at least a portion of the asset to be displayed on the first display at a third size that is larger than the first size, while the asset continues to be displayed on the second display at the second size and at the first aspect ratio.

At least one advantage of the disclosed embodiment is that the size and location of an asset in a digital collaboration environment can be modified on a local display device without affecting the size or location of the asset as displayed by remote display devices.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a display system configured to implement one or more aspects of the present invention.

FIG. 2 is a conceptual diagram of a collaboration system configured to share content streams between displays, according to various embodiments of the present invention.

FIG. 3 is a more detailed block diagram of the collaboration system of FIG. 2, according to various embodiments of the present invention.

FIG. 4 is a block diagram of a user device that may be employed as a display system in the collaboration system of FIG. 2, according to various embodiments of the present invention.

FIG. 5 illustrates a more detailed block diagram of the user device of FIG. 4, according to various embodiments of the present invention.

FIG. 6 is a flowchart of method steps for displaying content during a collaboration session, according to various embodiments of the present invention.

FIGS. 7A-7D depict the user device of FIG. 4 displaying content in focus mode, according to various embodiments of the present invention.

### DETAILED DESCRIPTION OF EXEMPLARY EMBODIMENTS

In the following description, numerous specific details are set forth to provide a more thorough understanding of the present invention. However, it will be apparent to one of skill in the art that the present invention may be practiced without one or more of these specific details.

### System Overview

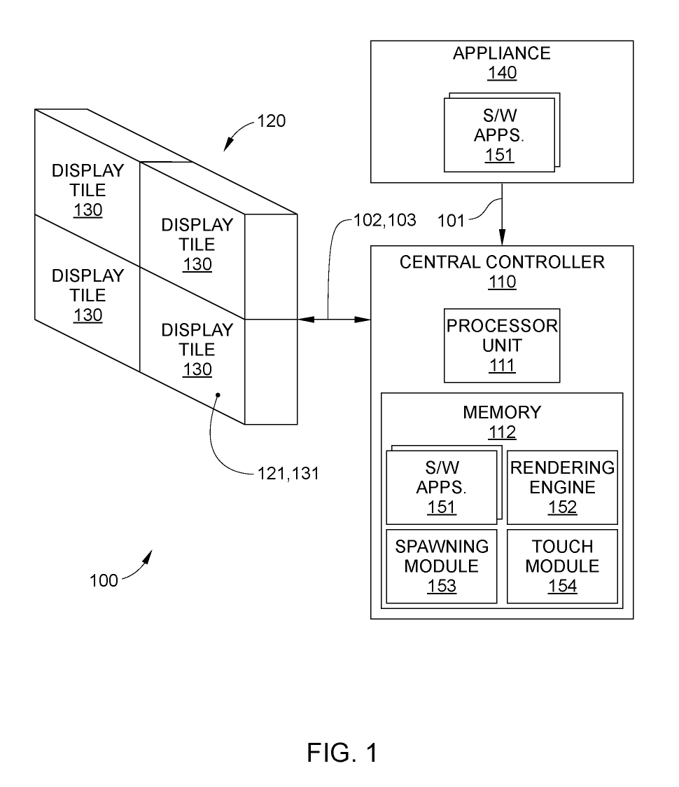

FIG. 1 is a block diagram of a display system 100 configured to implement one or more aspects of the present invention. As shown, display system 100 includes, without limitation, a central controller 110 and a display 120. In some embodiments, display 120 is a display wall that includes multiple display tiles. Central controller 110 receives digital image content 101 from an appliance 140 or from an information network or other data routing device, and converts said input into image data signals 102. Thus, digital image content 101 may be generated locally, with appliance 140, or from some other location. For example, when display system 100 is used for remote conferencing, digital image content 101 may be received via any technically feasible communications or information network, wired or wireless, that allows data exchange, such as a wide area network (WAN), a local area network (LAN), a wireless (Wi-Fi) network, and/or the Internet, among others.

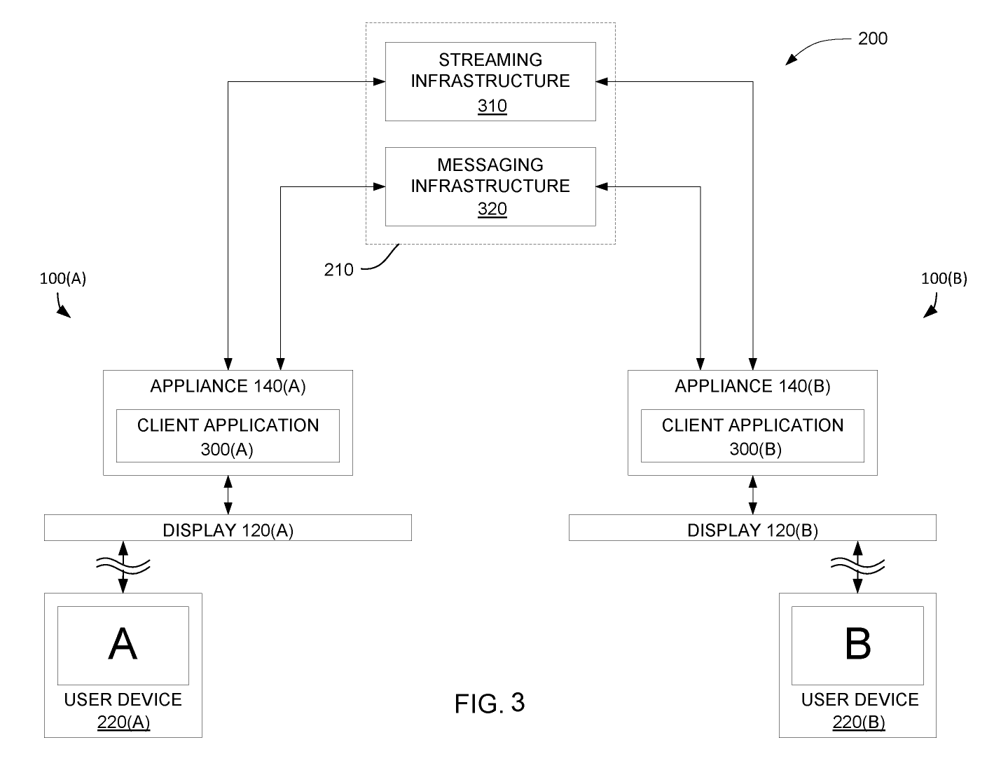

Central controller 110 includes a processor unit 111 and memory 112. Processor unit 111 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processor unit 111 may be any technically feasible hardware unit capable of processing data and/or executing software applications to facilitate operation of display system 100, including software applications 151, rendering engine 152, spawning module 153, and touch module 154. During operation, software applications 151, rendering engine 152, spawning module 153, and touch module 154 may reside in memory 112, and are described below in conjunction with FIG. 3. Alternatively or additionally, software applications 151 may also reside in appliance 140. In some embodiments, one or more of 151-154 may be implemented in firmware, either in central controller 110 and/or in other components of display system 100.

Memory 112 may include volatile memory, such as a random access memory (RAM) module, and non-volatile memory, such as a flash memory unit, a read-only memory (ROM), or a magnetic or optical disk drive, or any other type of memory unit or combination thereof. Memory 112 is configured to store any software programs, operating system, drivers, and the like, that facilitate operation of display system 100, including software applications 151, rendering engine 152, spawning module 153, and touch module 154.

Display 120 may include the display surface or surfaces of any technically feasible display device or system type, including but not limited to the display surface of a light-emitting diode (LED) display, a digital light (DLP) or other projection displays, a liquid crystal display (LCD), optical light emitting diode display (OLED), laser-phosphor display (LPD) and/or a stereo 3D display all arranged as a single stand alone display, head mounted display or as a single or multi-screen tiled array of displays. Display sizes may range from smaller handheld or head mounted display devices to full wall displays. In the example illustrated in FIG. 1, display 120 includes a plurality of display light engine and screen tiles 130 mounted in a 2×2 array. Other configurations and array dimensions of multiple electronic display devices, e.g. 1×4, 2×3, 5×6, etc., also fall within the scope of the present invention.

In operation, display 120 displays image data signals 102 output from controller 110. For a tiled display, as illustrated in FIG. 1, image data signals 102 are appropriately distributed among display tiles 130 such that a coherent image is displayed on a display surface 121 of display 120. Display surface 121 typically includes the combined display surfaces of display tiles 130. In addition, display 120 includes a touch-sensitive surface 131 that extends across part or all of the surface area of display tiles 130. In one embodiment, gesture-sensitive display surface or touch-sensitive surface 131 senses touch by detecting interference between a user and one or more beams of light, including, e.g., infrared laser beams. In other embodiments, touch sensitive surface 131 may rely on capacitive touch techniques, including surface capacitance, projected capacitance, or mutual capacitance, as well as optical techniques, acoustic wave-based touch detection, resistive touch approaches, and so forth, without limitation. Touch-sensitive surface 131 enables users to interact with assets displayed on the wall using touch gestures including tapping, dragging, swiping, and pinching. These touch gestures may replace or supplement the use of typical peripheral I/O devices such as an external keyboard or mouse, although touch-sensitive surface 131 may receive inputs from such devices, as well.

In the context of this disclosure, an “asset” may refer to any interactive renderable content that can be displayed on a display, such as display 120, among others. Such interactive renderable content is generally derived from one or more persistent or non-persistent content streams that include sequential frames of video data, corresponding audio data, metadata, flowable/reflowable unstructured content, and potentially other types of data. Generally, an asset may be displayed within a dynamically adjustable presentation window. For simplicity, an asset and corresponding dynamically adjustable presentation window are generally referred to herein as a single entity, i.e., an “asset.” Assets may include images, videos, web browsers, documents, renderings of laptop screens, presentation slides, any other graphical user interface (GUI) of a software application, and the like. An asset generally includes at least one display output generated by a software application, such as a GUI of the software application. In one embodiment, the display output is a portion of a content stream. In addition, an asset is generally configured to receive one or more software application inputs via a gesture-sensitive display surface of a collaboration client system 140, i.e., inputs received via the gesture-sensitive display surface are received by the asset and treated as input for the software application associated with the asset. Thus, unlike a fixed image, an asset is a dynamic element that enables interaction with the software application associated with the asset, for example, for manipulation of the asset. For example, an asset may include select buttons, pull-down menus, control sliders, etc. that are associated with the software application and can provide inputs to the software application.

As also referred to herein, a “workspace” is a digital canvas on which assets associated therewith, and corresponding content streams, are displayed within a suitable dynamic presentation window on display 120. Typically, a workspace corresponds to the all of the potential render space of display 120, so that only a single workspace can be displayed on the surface thereof. However, in some embodiments, multiple workspaces may be displayed on display 120 concurrently, such as when a workspace does not correspond to the entire display surface. Assets associated with a workspace, and content streams corresponding to those assets, are typically displayed in the workspace within a suitable presentation window that has user-adjustable display height, width, and location. Generally, a workspace is associated with a particular project, which is typically a collection of multiple workspaces.

In one embodiment, a server stores metadata associated with specific assets, workspaces, and/or projects that is accessible to display system 100. For example, such metadata may include which assets are associated with a particular workspace, which workspaces are associated with a particular project, the state of various setting for each workspace, annotations made to specific assets, etc. In some embodiments, asset metadata may also include size of the presentation window associated with the asset and position of the presentation window in a particular workspace, and, more generally, other types of display attributes. In some embodiments, asset size and location metadata may be calculated metadata that are dimensionless. In such embodiments, the asset size may be in terms of aspect ratio, and asset position in terms of percent location along an x- and y-axis of the associated workspace. Thus, when instances of display 120 are not uniformly sized, each asset within a collaboration or shared workspace can still be positioned and sized proportional to the specific instance of display 120 in which is it being displayed. When multiple display systems 100 separately display a similar shared workspace, each such display system 100 may configure the local version of that shared workspace based on the corresponding metadata.

Touch-sensitive surface 131 may be a “multi-touch” surface, which can recognize more than one point of contact on display 120, enabling the recognition of complex gestures, such as two or three-finger swipes, pinch gestures, and rotation gestures as well as multiuser two, four, six etc. hands touch or gestures. Thus, one or more users may interact with assets on display 120 using touch gestures such as dragging to reposition assets on the screen, tapping assets to display menu options, swiping to page through assets, or using pinch gestures to resize assets. Multiple users may also interact with assets on the screen simultaneously. Again, examples of assets include application environments, images, videos, web browsers, documents, mirroring or renderings of laptop screens, presentation slides, content streams, and so forth. Touch signals 103 are sent from a touch panel associated with a display 120 to central controller 110 for processing and interpretation.

It will be appreciated that the system shown herein is illustrative and that variations and modifications are possible. For example, software applications 151, rendering engine 152, spawning module 153, and touch module 154 may reside outside of central controller 110.

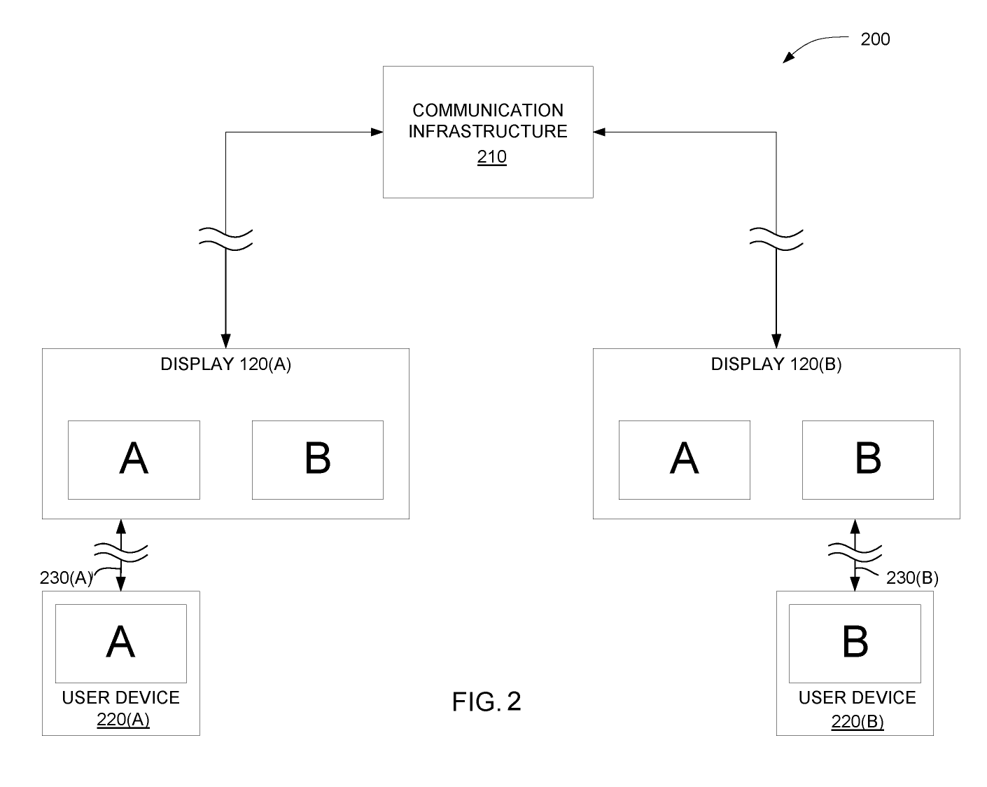

FIG. 2 is a conceptual diagram of a collaboration system 200 configured to share content streams between displays, according to one embodiment of the present invention. As shown, collaboration system 200 includes displays 120(A) and 120(B) coupled together via a communication infrastructure 210. In one embodiment, each of displays 120(A) and/or 120(B) represents a different instance of display 120 of FIG. 1. Alternatively, display 120(A) and/or 120(B) represent a display screen incorporated into a mobile computing device, such as an electronic tablet, a smartphone, a laptop, and the like.

Display 120(A) is coupled to a user device 220(A) via a data connection 230(A). In one embodiment, display 120(A) forms part of an overarching instance of display system 100 of FIG. 1, to which user device 220(A) may be coupled. User device 220(A) may be a computing device, a video capture device, or any other type of hardware configured to generate content streams for display. In FIG. 2, user device 220(A) generates and displays content stream A. In one embodiment, content stream A is a stream of video content that reflects the display output of user device 220(A). When coupled to display 120(A), user device 220(A) also outputs content stream A to display 120(A) via data connection 230(A). In doing so, user device 220(A) may execute a software application to coordinate communication with display 120(A) via data connection 230(A). Data connection 230(A) may be a high-definition multimedia interface (HDMI) cable, analog connection, wireless connection, or any other technically feasible type of data connection. In response to receiving content stream A, display 120(A) displays content stream A, as is shown.

Similar to display 120(A), display 120(B) is coupled to a user device 220(B) via a data connection 230(B). In one embodiment, display 120(B) forms part of an overarching instance of display system 100 of FIG. 1, to which user device 220(B) may be coupled. User device 220(B) may be a computing device, a video capture device, or any other type of hardware configured to generate content streams for display. In FIG. 2, user device 220(B) generates and displays content stream B. In one embodiment, content stream B is a stream of video content that reflects some or all of the display output of user device 220(B). When coupled to display 120(B), user device 220(B) also outputs content stream B to display 120(B) via data connection 230(B). In doing so, user device 220(B) may execute a software application to coordinate communication with display 120(B) via data connection 220(B). Data connection 230(B) may be a high-definition multimedia interface (HDMI) cable, analog connection, wireless connection, or any other technically feasible type of data connection. In response to receiving content stream B, display 120(B) displays content stream B, as is shown.

As mentioned above, displays 120(A) and 120(B) may be included within respective instances of display system 100. In such embodiments, the display systems that include displays 120(A) and 120(B) are configured to interoperate in order to share content streams received locally, as described in greater detail below in conjunction with FIG. 3.

FIG. 3 is a more detailed block diagram of the collaboration system of FIG. 2, according to one embodiment of the present invention. As shown, FIG. 3 illustrates similar components as those described above in conjunction with FIG. 2, with certain components illustrated in greater detail. In particular, communication infrastructure 210 is shown to include streaming infrastructure 310 and messaging infrastructure 320. Additionally, display system 100(A) is shown to include appliance 140(A) as well as display 120(A), and display system 100(B) is shown to include appliance 140(B) as well as display 120(B). Appliances 140(A) and 140(B) include client applications 300(A) and 300(B), respectively.

Display system 100(A) is configured to share content stream A, via communication infrastructure 210, with display system 100(B). In response, display system 100(B) is configured to retrieve content stream A from communication infrastructure 210 and to display that content stream on display 120(B) with content stream B. Likewise, display system 100(B) is configured to share content stream B, via communication infrastructure 210, with display system 100(A). In response, display system 100(A) is configured to retrieve content stream B from communication infrastructure 210 and to display that content stream on display 120(A) with content stream A. In this fashion, display systems 100(A) and 100(B) are configured to coordinate with one another to generate a collaboration or shared workspace that includes content streams A and B. Content streams A and B may be used to generate different assets rendered within the shared workspace. In one embodiment, each of display systems 100(A) and 100(B) perform a similar process to reconstruct the shared workspace, thereby generating a local version of that workspace that is similar to a local version of the workspace reconstructed at other display systems. As a general matter, the functionality of display systems 100(A) and 100(B) are coordinated by client applications 300(A) and 300(B), respectively.

Client applications 300(A) and 300(B) are software programs that generally reside within a memory (not shown) associated with the respective appliances 140(A) and 140(B). Client applications 300(A) and 300(B) may be executed by a processor unit (not shown) included within the respective computing devices. When executed, client applications 300(A) and 300(B) setup and manage the shared workspace discussed above in conjunction with FIG. 2, which, again, includes content streams A and B. In one embodiment, the shared workspace is defined by metadata that is accessible by both display systems 100(A) and 100(B). Each such display system may generate a local version of the shared workspace that is substantially synchronized with the other local version, based on that metadata.

In doing so, client application 300(A) is configured to transmit content stream A to streaming infrastructure 310 for subsequent streaming to display system 100(B). Client application 300(A) also transmits a notification to display system 100(B), via messaging infrastructure 320, that indicates to display system 100(B) that content stream A is available and can be accessed at a location reflected in the notification. In like fashion, client application 300(B) is configured to transmit content stream B to streaming infrastructure 310 for subsequent streaming to display system 100(A). Client application 300(B) also transmits a notification to display system 100(A), via messaging infrastructure 320, that indicates to display system 100(A) that content stream B is available and can be accessed at a location reflected in the notification. The notification indicates that access may occur from a location within streaming infrastructure 310.

Referring generally to FIGS. 2 and 3, in operation, when user device 220(A) is connected to display system 100(A), client application 300(A) detects this connection by interacting with software executing on user device 220(A). Client application 300(A) then coordinates the streaming of content stream A from user device 220(A) to appliance 140(A). In response to receiving content stream A, appliance 140(A), or a central controller coupled thereto, decodes and then renders that content stream to display 120(A) in real time. Through this technique, client application 300(A) causes content stream A, derived from user device 220(A), to appear on display 120(A), as shown in FIG. 2.

In addition, client application 300(A) re-encodes the decoded content stream to a specific format and then streams that content stream to streaming infrastructure 310 for buffering and subsequent streaming to display system 100(B), as also mentioned above. The specific format could be, for example, a Motion Picture Experts Group (MPEG) format, among others. Streaming infrastructure 310 provides access to the buffered content stream at a specific location that is unique to that content. The specific location is derived from an identifier associated with display system 100(A) and an identifier associated with user device 220(A). The location could be, for example, a uniform resource locator (URL), an address, a port number, or another type of locator. Streaming infrastructure 310 may buffer the content stream using any technically feasible approach to buffering streaming content.

In one embodiment, the aforesaid identifiers include a license key associated with display system 100(A), and an index that is assigned to user device 220(A). Display system 100(A) may assign the index to user device 220(A) when user device 220(A) is initially connected thereto. In a further embodiment, streaming infrastructure 310 provides access to content stream A at a URL that reflects a base URL combined with the license key and the index.

In conjunction with streaming content stream A to streaming infrastructure 310, client application 300(A) also broadcasts a notification via messaging infrastructure 320 to display system 100(B). The notification includes the identifiers, mentioned above, that are associated with display system 100(A) and, possibly, user device 220(A). The notification may also include data that specifies various attributes associated with content stream A that may be used to display content stream A. The attributes may include a position, a picture size, an aspect ratio, or a resolution with which to display content stream A on display 120(B), among others, and may be included within metadata described above in conjunction with FIG. 1.

In response to receiving this notification, client application 300(B) parses the identifiers mentioned above from the notification and then accesses content stream A from the location corresponding to those identifiers. Again, in one embodiment, the location is a URL that reflects a license key associated with display system 100(A) and an index associated with user device 220(A). Client application 300(B) may also extract the aforesaid attributes from messaging infrastructure 320, and then display content stream A at a particular position on display 120(B), with a specific picture size, aspect ratio, and resolution, as provided by messaging infrastructure 320. Through this technique, display system 100(A) is capable of sharing content stream A with display system 100(B).

Display system 100(B) is configured to perform a complimentary technique in order to share content stream B with display system 100(A). Specifically, when user device 220(B) is connected to display system 100(B), client application 300(B) detects this connection by interacting with software executing on user device 220(B), then coordinates the streaming of content stream B from user device 220(B) to appliance 140(B). In response to receiving content stream B, appliance 140(B), or a central controller coupled thereto, decodes and then renders content stream B to display 120(B) in real time. Through this technique, client application 300(B) causes content stream B, derived from computing user device 220(B), to appear on display 120(B), as also shown in FIG. 2.

In addition, client application 300(B) re-encodes the decoded content stream to a specific format and then streams that content stream to streaming infrastructure 310 for buffering and subsequent streaming to display system 100(A), as also mentioned above. The specific format could be, for example, an MPEG format, among others. Streaming infrastructure 310 provides access to the buffered content stream at a specific location that is unique to that content. The specific location is derived from an identifier associated with display system 100(B) and an identifier associated with user device 220(B). The location could be, for example, a URL, an address, a port number, or another type of locator.

In one embodiment, the aforesaid identifiers include a license key associated with display system 100(B), and an index that is assigned to user device 220(B). Display system 100(B) may assign the index to user device 220(B) when user device 220(B) is initially connected thereto. In a further embodiment, streaming infrastructure 310 provides access to content stream B at a URL that reflects a base URL combined with the license key and the index.

In conjunction with streaming content stream B to streaming infrastructure 310, client application 300(B) also broadcasts a notification across messaging infrastructure 320 to display system 100(A). The notification includes the identifiers, mentioned above, that are associated with display system 100(B) and user device 220(B). The notification may also include data that specifies various attributes associated with content stream B that may be used to display content stream B. The attributes may include a position, a picture size, an aspect ratio, or a resolution with which to display content stream B on display 120(A), among others.

In response to receiving this notification, client application 300(A) parses the identifiers mentioned above from the notification and then accesses content stream B from the location corresponding to those identifiers. Again, in one embodiment, the location is a URL that reflects a license key associated with display system 100(B) and an index associated with user device 220(B). Client application 300(A) may also extract the aforesaid attributes, and then display content stream B at a particular position on display 120(A), with a specific picture size, aspect ratio, and resolution which may or may not have the same or partially overlapping position on display 120(A), with one or more of the a specific picture size, aspect ratio, and resolution as stream A. Through this technique, display system 100(B) is capable of sharing content stream B with display system 100(A).

Client applications 300(A) and 300(B) are thus configured to perform similar techniques in order to share content streams A and B, respectively with one another. When client application 300(A) renders content stream A on display 120(A) and, also, streams content stream B from streaming infrastructure 310, display system 100(A) thus constructs a version of a shared workspace that includes content stream A and B. Similarly, when client application 300(B) renders content stream B on display 120(B) and, also, streams content stream A from streaming infrastructure 310, display system 100(A) similarly constructs a version of that shared workspace that includes content streams A and B.

The display systems 100(A) and 100(B) discussed herein are generally coupled together via streaming infrastructure 310 and messaging infrastructure 320. Each of these different infrastructures may include hardware that is cloud-based and/or collocated on-premises with the various display systems. However, persons skilled in the art will recognize that a wide variety of different approaches may be implemented to stream content streams and transport notifications between display systems.

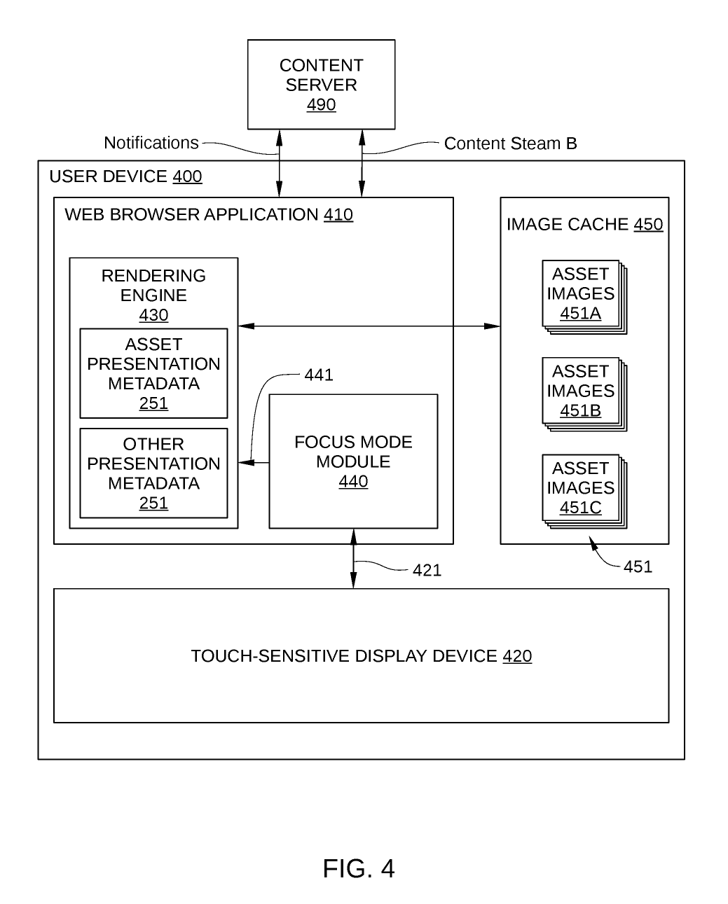

According to one or more embodiments of the invention, a display system in a collaboration system is configured with a focus mode that can be triggered for a selected asset. The focus mode enables changes in presentation of the selected asset to be made at the display system without the presentation changes being mirrored by other display systems in the collaboration system. More specifically, when the focus mode is triggered for the selected asset, the size and/or location of the asset can be modified, for example expanded in size, to be readable on a hand-held device. To prevent the presentation changes to be mirrored at other display systems in the collaboration system, presentation metadata associated with the selected asset are not included in notifications broadcast across messaging infrastructure 320. Thus, when the display system configured with the focus mode is a hand-held or other computing device with a small display screen, an asset can be expanded to fill most or all of the display screen of the display system. An embodiment of one such display system is illustrated in FIG. 4.

FIG. 4 is a block diagram of a user device 400, configured according to various embodiments of the present invention. User device 400 may be substantially similar to display system 100(A) or 100(B) of FIG. 2, except that, unlike display systems 100(A) or 100(B), user device 400 may be a mobile computing device that incorporates a display screen 420 rather than display device 120(A) or 120(B). For example, user device 400 may be a suitably configured laptop, an electronic tablet, or a smartphone. Thus, display screen 420 may be a conventional display screen or a gesture-sensitive or touch-sensitive display screen, and may be configured to receive and generate input signals in response to one or more touch-based gestures (e.g., tap, drag, pinch, etc.) and/or to one or more pointing device inputs, such as mouse or stylus inputs. In some embodiments, user device 400 is configured to execute a web browser application 410, a rendering engine 430, and a focus mode module 440, and to store an image cache 450. For purposes of illustration, display system 100(A) is hereinafter assumed to be user device 400 in collaboration system 200.

Web browser application 410 may be any suitable web browser application that enables completion of server requests to a content or collaboration server 490 in communication infrastructure 210, and otherwise facilitates operation of rendering engine 430 and focus mode module 440 as described herein. More specifically, in some embodiments, web browser application 410 enables the flow of a content stream, such as content stream A, via streaming infrastructure 310, from user device 400 to display system 100(B), and the flow of content stream B, via streaming infrastructure 310, from client application 300(B) to user device 400. In addition, web browser application 410 enables the transmission via messaging infrastructure 320 of notifications from user device 400 to display system 100(B) and the transmission of notifications from client application 300(B) to user device 400. Examples of web browsers suitable for use as web browser application 410 include Mozilla, Internet Explorer, Safari, Chrome, and the like.

Collaboration server 490 coordinates the flow of information between the various collaboration system clients of collaboration system 200, such as user device 400 and display system 100(B). Thus, in some embodiments, collaboration server 490 is a streaming server for user device 400 and display system 100(B). In addition, collaboration server 490 receives requests from user device 400 and display system 100(B), and can send notifications to user device 400 and display system 100(B). Therefore, there is generally a two-way connection between collaboration server 490 and each client of collaboration system 200, such as user device 400 and display system 100(B). For example, during collaborative work on a particular project via collaboration system 200, a client of collaboration system 200 may send a request to collaboration server 490 for information associated with an interactive window asset to display the asset in a workspace of the particular project. In such embodiments, the functionality of user device 400 and display system 100(B) are coordinated by rendering engine 430 and client application 300(B), respectively, to reconstruct a collaboration or shared workspace by generating a local version of that workspace.

Collaboration server 490 may include a processor 491 and a memory 492. Processor 491 may be any suitable processor implemented as a central processing unit (CPU), a graphics processing unit (GPU), an application-specific integrated circuit (ASIC), a field programmable gate array (FPGA), any other type of processing unit, or a combination of different processing units. In the context of this disclosure, the computing elements shown in collaboration server 490 may correspond to a physical computing system (e.g., a system in a data center) or may be a virtual computing instance executing within a computing cloud. Memory 492 may include a volatile memory, such as a random access memory (RAM) module, and non-volatile memory, such as a flash memory unit, a read-only memory (ROM), one or more hard disk drives, or any other type of memory unit or combination thereof suitable for use in collaboration server 490. Memory 492 is configured to store any software programs, operating system, drivers, and the like, that facilitate operation of collaboration server 490.

Rendering engine 430 is configured to render certain image data, such as image data associated with a particular asset, as an image that is displayed on display screen 420. For example, rendering engine 430 is configured to receive image data via content stream B, and render such image data on display screen 420. In addition, rendering engine 430 is configured to receive user requests 441 from focus mode module 440, and translate user requests 441 into suitable images that are displayed by display screen 420. For example, in embodiments in which a user request 441 includes a request for a particular image, such as an image of a particular asset, rendering engine 430 determines whether that particular image is currently stored in image cache 450 and, if not, forwards the request for the particular image to collaboration server 490 via web browser application 410. In such embodiments, user request 441 may request particular images with a specific Uniform Resource Locator (URL), and rendering engine 430 may determine whether the image is already stored locally in image cache 450 based on the URL. When the URL included in user request 441 indicates the image is stored locally in image cache 450, rendering engine 430 retrieves the image from image cache 450.

In some embodiments, rendering engine 430 includes asset presentation metadata 431 and other asset metadata 432. Alternatively, rendering engine 430 includes references to locations in a memory storing asset presentation metadata 431 and other asset metadata 432. Asset presentation metadata 431 includes specific information for each asset related to how the asset is presented at each client of collaboration system 200, such as user device 400 and display system 100(B). For example, in some embodiments, presentation metadata 431 includes picture size, aspect ratio, and location of the asset in a workspace. By contrast, other asset metadata 432 includes information for each asset that is not related to the rendering or display of the asset. For example, in some embodiments, other asset metadata 432 includes data that specifies various attributes associated with each asset, such as annotations made to a particular asset, settings associated with the asset (play head time, current volume, etc.), and status of the asset (is video paused, is asset selected for annotation, etc.).

Rendering engine 430 is also configured to transmit appropriate notifications to other clients of collaboration system 200 in response to user requests 441. According to embodiments of the invention, when focus mode for a particular asset is triggered, rendering engine 430 is configured to modify notifications to display system 100(B) from user device 400. Specifically, presentation metadata 431 are not updated in notifications to other clients of collaboration system 200, while other asset metadata 432 are still updated. As a result, changes in presentation of that particular asset, when requested at user device 400, are not reflected at these other clients of collaboration system 200, while annotations and other changes associated with the asset are mirrored at the other clients. Thus, a user employing user device 400 to collaborate with other collaboration locations can zoom, pan, or otherwise change presentation of the particular asset without affecting presentation of the asset at other collaboration locations. In some embodiments, a user employing user device 400 to collaborate with other collaboration locations can zoom, pan, or otherwise change presentation of the particular asset without affecting presentation of the asset at other collaboration locations. However, metadata information associated with zooming, panning, or other changes in the presentation of the particular asset may be presented to other collaboration locations, and presented in a manner that informs other collaborators of the local activity of the user employing user device 400.

Focus mode module 440 is configured to receive user inputs 421 from display screen 420 or other input devices, such as a mouse, a stylus, or speech and, based on user inputs 421, to generate user requests 441. Focus mode module 440 is further configured to interpret user inputs 421 and provide user requests 441 to rendering engine 430. User inputs 421 may include signals generated by display screen 420 in response to one or more touch-based gestures (e.g., tap, drag, pinch, etc.) and/or to one or more pointing device inputs, such as mouse or stylus inputs. Generally, such signals generated by display screen 420 are associated with a particular asset displayed by display screen 420. For example, when an input from a touch-based gesture or pointing device is received from a region of display screen 420 that corresponds to a particular displayed asset, the user inputs 421 that are generated are associated with that particular asset.

Focus mode module 440 generates a different user request 441, depending on what type of user input 421 is made on display screen 420, and on what location on display screen 420 user input 421 is performed. For example, user request 441 may include a focus mode triggering input that triggers focus mode for the particular asset, such as when a specific focus mode button included in a graphical user interface (GUI) associated with an asset is tapped.

Alternatively or additionally, user input 421 can include a presentation change input, such as a position change input, a location change input, a zoom input, and the like. In response to receiving presentation change inputs, focus mode module 440 generates an appropriate user request 441 that is received by rendering engine 430, that requested the presentation change indicated by user input 421. As noted above, when focus mode for a particular asset is triggered, notifications to display system 100(B) from user device 400 are modified by rendering engine 430, so that presentation metadata 431 is not updated in notifications to other clients of collaboration system 200, while other asset metadata 432 are still updated.

User input 421 can also include a non-presentation change input for the asset that does not affect presentation of the asset. For example, one non-presentation input included in user input 421 may be an annotation input for the asset, in which an annotation is added to the asset. In response to receiving the non-presentation change input, focus mode module 440 generates an appropriate user request 441 that is received by rendering engine 430 and indicates the non-presentation request indicated by user input 421. Unlike presentation change inputs, when rendering engine 430 receives non-presentation change inputs, notifications from user device 400 to display system 100(B) and/or other clients are not modified by rendering engine 430, and may include updated other asset metadata 432 that are then mirrored at display system 100(B) and/or other clients of collaboration system 200. It is noted that when focus mode is exited for a particular asset, the image of the asset being displayed in focus mode disappears, and the collaboration for user device 400 resumes normally.

Image cache 450 is configured to store images 451 associated with the various assets included in the workspace currently displayed by user device 400 and display systems 100(B). In some embodiments, multiple images 451 stored in image cache 450 may be associated with a single asset. For instance, for each page or sheet of a document, image cache 450 may include at least one image. Thus, when a workspace includes an asset that is a 10-page document, an image is stored for each page of the asset. In such embodiments, the resolution of the image stored may be based on a resolution of display screen 420. For example, in an embodiment in which user device 400 is a smartphone with a 1334×750 pixel screen, the resolution of an image stored in image cache 450 may have a resolution that is equal to or less than 1334×750 pixels. However, when a request is made to zoom into an asset, a higher resolution image for that asset may be requested and downloaded from collaboration server 490. In some embodiments, the asset may be stored on the local client device and the request for a higher resolution image for that asset may be generated on the local client device.

In some embodiments, multiple images stored in image cache 450 may be associated with a single page or sheet of a particular asset. For example, each of images 451A may be associated with one page of an asset, where each is a different resolution image of that page of the asset. Similarly, images 451B may be associated with another page of the asset, and images 451C may be associated with yet another page of the asset. Thus, if a user requests a zoomed view of particular a page of an asset for which focus mode has been triggered, higher resolution images of the page can be accessed with very low latency and an enhanced user experience.

In some embodiments, images 451 may be stored in image cache 450 whenever the presentation of an asset is updated at display system 100(B) or any other client of collaboration system 200. In such embodiments, the storage of images 451 for different resolution images may be performed in the background.

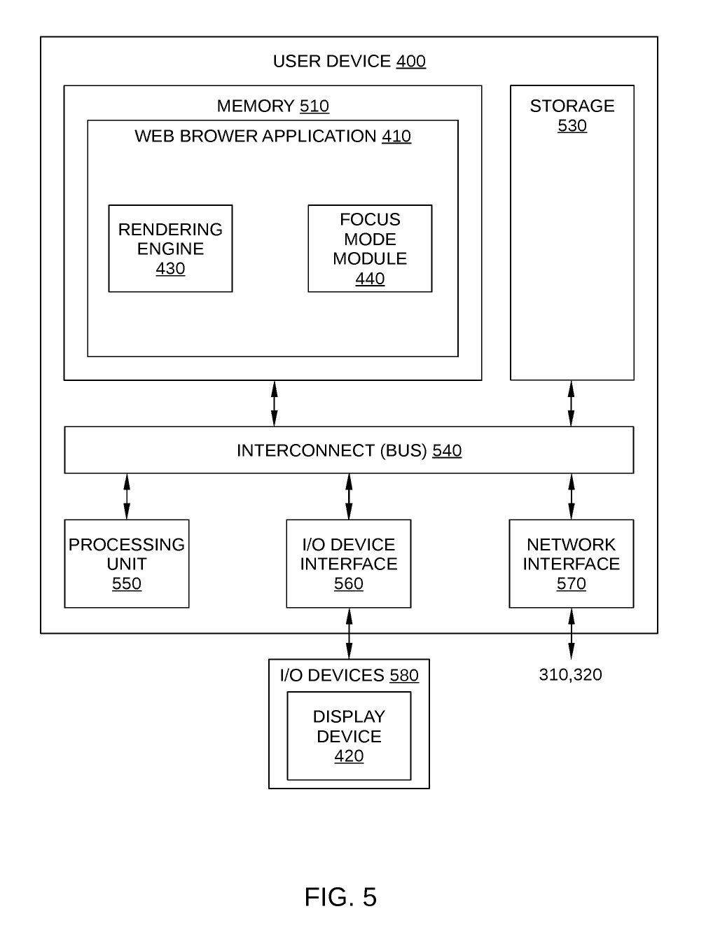

FIG. 5 illustrates a more detailed block diagram of user device 400, according to various embodiments of the present invention. User device 400 may be a desktop computer, a laptop computer, a smart phone, a personal digital assistant (PDA), video game console, set top console, tablet computer, or any other type of computing device configured to receive input, process data, and display images, and is suitable for practicing one or more embodiments of the present invention. User device 400 is configured to run web browser application 410, rendering engine 430, and focus mode module 440, which reside in a memory 510. It is noted that the user device described herein is illustrative and that any other technically feasible configurations fall within the scope of the present invention.

As shown, user device 400 includes, without limitation, an interconnect (bus) 540 that connects a processing unit 550, an input/output (I/O) device interface 560 coupled to input/output (I/O) devices 580, memory 510, a storage 530, and a network interface 570. Processing unit 550 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 550 may be any technically feasible hardware unit capable of processing data and/or executing software applications, including web browser application 410, rendering engine 430, and focus mode module 440.

I/O devices 580 may include devices capable of providing input, such as a keyboard, a mouse, display screen 420, and so forth, as well as devices capable of providing output, such as display screen 420. Display screen 420 may be a computer monitor, a video display screen, a display apparatus incorporated into a hand held device, or any other technically feasible display screen configured to present dynamic or animated media to an end-user. I/O devices 580 may be configured to receive various types of input from an end-user of user device 400, and to also provide various types of output to the end-user of user device 400, such as displayed digital images or digital videos. In some embodiments, one or more of I/O devices 580 are configured to couple user device 400 to streaming infrastructure 310 and/or messaging infrastructure 320.

Memory 510 may include a random access memory (RAM) module, a flash memory unit, or any other type of memory unit or combination thereof. Processing unit 550, I/O device interface 560, and network interface 570 are configured to read data from and write data to memory 510. Memory 510 includes various software programs that can be executed by processor 550 and application data associated with said software programs, including web browser application 410, rendering engine 430, and focus mode module 440.

In the embodiments of FIGS. 4 and 5, rendering engine 430 and focus mode module 440 are described in terms of a browser-based application. In other embodiments, rendering engine 430 and focus mode module 440 may be implemented as a downloadable application configured for use in a smartphone, or as a non-web browser software application executed on a desktop computer.

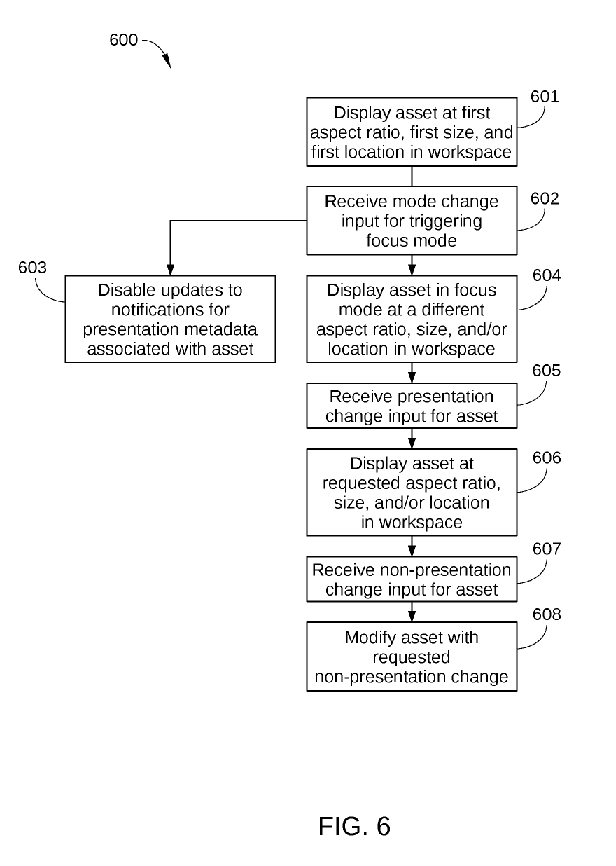

FIG. 6 is a flowchart of method steps for displaying content during a collaboration session, according to various embodiments of the present invention. Although the method steps are described in conjunction with the systems of FIGS. 1-5, persons skilled in the art will understand that any system configured to perform the method steps, in any order, is within the scope of the present invention.

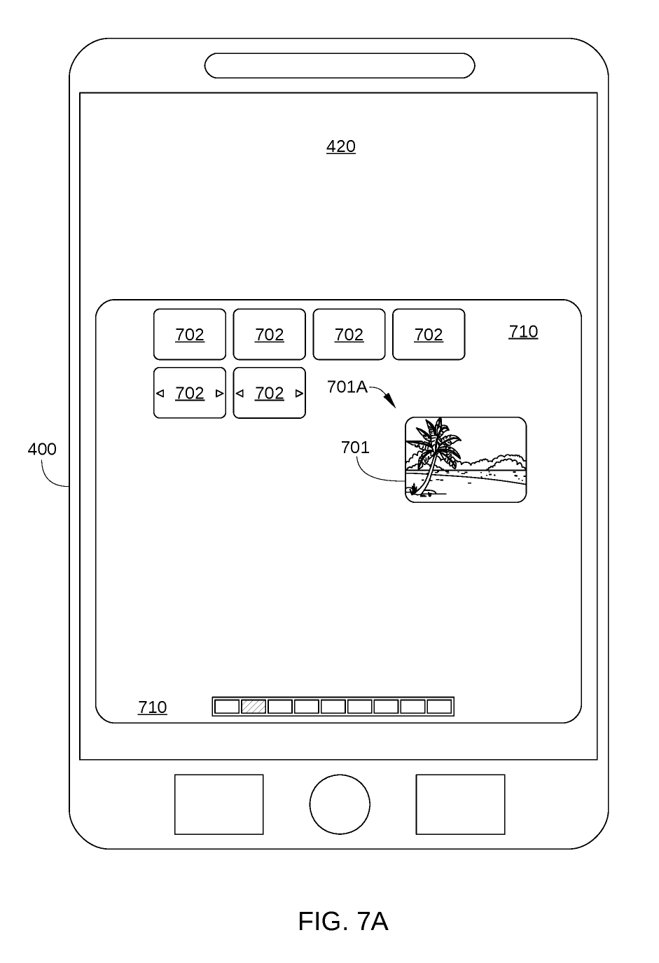

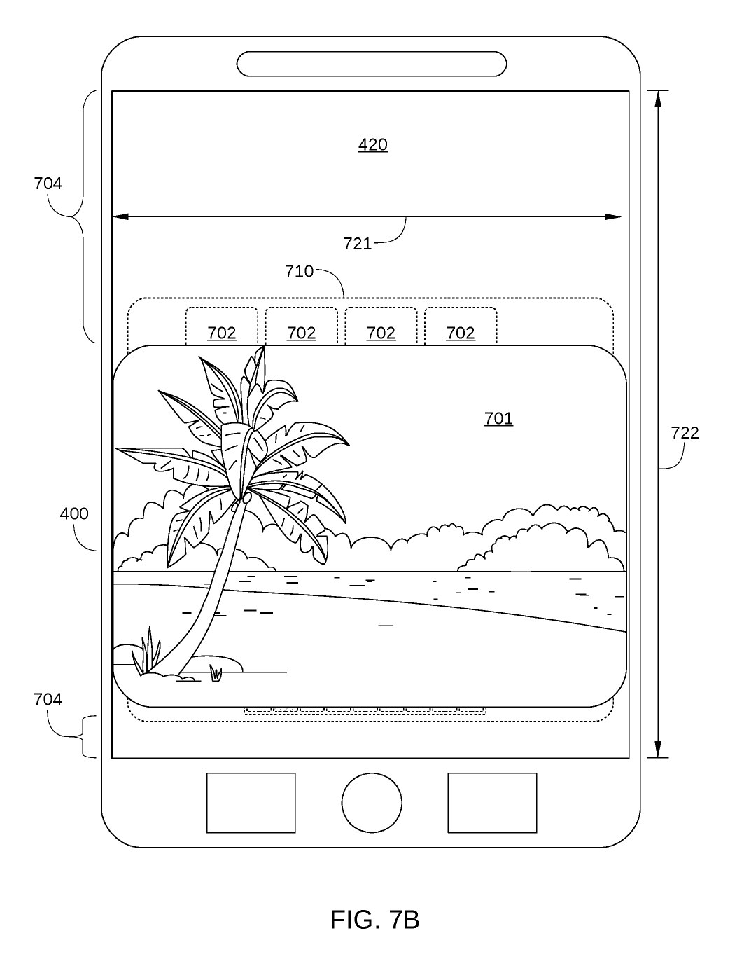

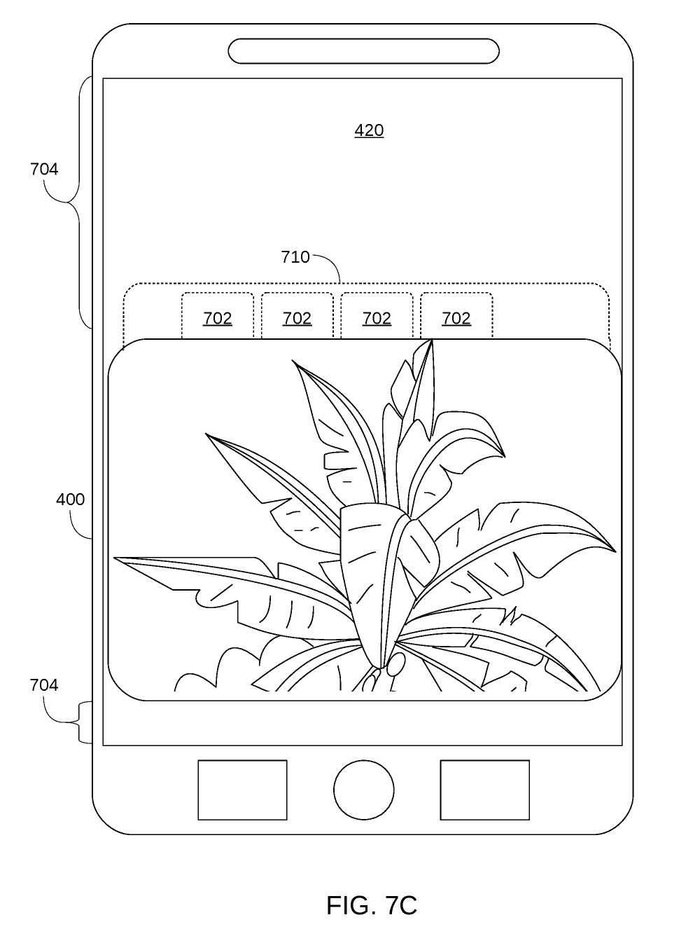

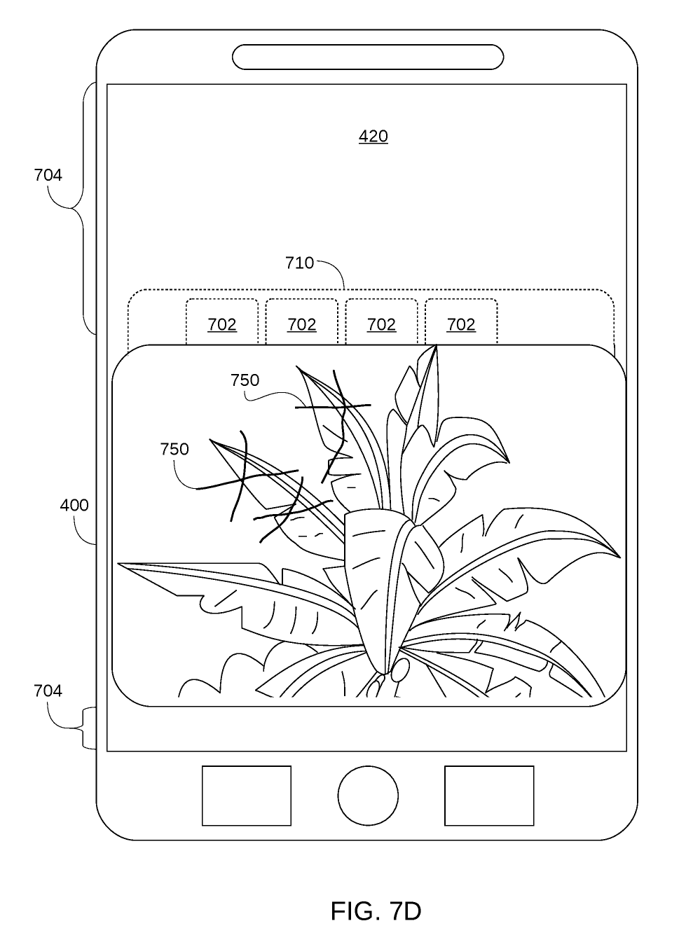

As shown, a method 600 begins at step 601, where rendering engine 430 causes an asset to be displayed on a display surface associated with user device 400, as illustrated in FIG. 7A. For example, an asset 701 is displayed on display screen 420, as part of a common workspace 710. Asset 701 is displayed at a first size (such as fractional width and height of workspace 710), at a first aspect ratio (height vs. width), and at a first location 701A within collaboration or common workspace 710. One or more additional assets 702 are also displayed on touch-sensitive screen 420 as part of common workspace 710. Because touch-sensitive screen 420 is a relatively small screen, in order for all of common workspace 710 to be visible, asset 701 may be scaled to a size that is too small to be comfortably viewable. However, even when common workspace 710 is enlarged to extend beyond the limits of display screen 420, asset 701 may be difficult to view comfortably on display screen 420. It is noted that, in step 601, asset 701 is simultaneously displayed by other clients of collaboration system 200 at location 701A in common workspace 710, at the first size, and at the first aspect ratio at which asset 701 is displayed on display screen 420.

In step 602, rendering engine 430 receives a mode change input from focus mode module 440 indicating that focus mode has been triggered for asset 701.

In step 603, rendering engine 430 disables updates to notifications for presentation metadata associated with asset 701. Thus, while focus mode is triggered for asset 701, notifications to display system 100(B) and other clients of collaboration system 200 are not updated with changes to the size, aspect ratio, and location of asset 701 within common workspace 710. As a result, when rendering engine 430 causes the presentation of asset 701 to be modified at display screen 420, the size, aspect ratio, and location of asset 701 remains constant when displayed at other clients of collaboration system 200.

In step 604, rendering engine 430 causes an image of asset 701 to be displayed in focus mode on display screen 420, such as one of images 451 in image cache 450. Thus, asset 701 is displayed at a different size, aspect ratio, and/or location than the first size, the first aspect ratio, and/or the first location 701A within common workspace 710, as shown in FIG. 7B. For example, in some embodiments, rendering engine 430 scales the image of asset 701 to fit one of a maximum horizontal display dimension 721 associated with display surface 420 and a maximum vertical display dimension 722 associated with display screen 420. In such embodiments, asset 701 may not entirely fill the usable portion of display screen 420. That is, one or more regions 704 are not employed to display asset 701. In such embodiments, regions 704 may be employed to display portions of common workspace 710, as shown. In such embodiments, such portions of common workspace 710, including additional assets 702, may be blurred, rendered partially transparent, or otherwise obscured. It is noted that in some embodiments, in focus mode asset 701 may also be visible in regions 704 as part of common workspace 710.

In step 605, rendering engine 430 receives a presentation change input from focus mode module 440 via a user request 441. For example, a user may perform a zoom gesture on touch-sensitive screen 420 to request a zoom operation on asset 701.

In step 606, in response to receiving the presentation change input in step 605, rendering engine 430 causes asset 701 to be displayed on display screen 420 at a requested size, aspect ratio, and/or location that is different than that in step 604, as shown in FIG. 7C. For example, asset 701 may be displayed zoomed in, zoomed out, or panned relative to how asset 701 was displayed in step 604. However, it is noted that, in step 606, asset 701 is simultaneously displayed by other clients of collaboration system 200 at location 701A in common workspace 710, at the first size, and at the first aspect ratio. In some embodiments, the background workspace visible in regions 704, i.e., common workspace 710, still reflects what is happening within common workspace 710 at other collaboration workspace.

In step 607, rendering engine 430 receives a non-presentation change input from focus mode module 440 via a user request 441, or via a notification from collaboration server 490. For example, a user at a different client of collaboration system 200 may select asset 701 as an asset to annotate, or an annotation may actually be performed on asset 701 at user device 400.

In step 608, rendering engine 430 modifies asset 701 with an annotation 750 or other non-presentation change requested by the non-presentation change input received in step 607, as shown in FIG. 7D. In the embodiment illustrated in FIG. 7D, an annotation 750 is depicted, where the annotation 750 may be implemented locally on user device 400 or on another client of collaboration system 200. In either case, annotation 750 is not a presentation change of asset 701, and therefore is mirrored at the various collaboration system clients of collaboration system 200.

In alternative embodiments, in step 608, rendering engine 430 receives an annotation input from display screen 420 via focus mode module 440, i.e. from an input made by a user of user device 400. In such embodiments, the annotation input may include information and metadata associated with a particular annotation made via display screen 420 by the user of user device 400. Further, the particular annotation input is associated with the image of asset 701. Thus, in such embodiments, the annotation input may include image data for the particular annotation (such as an image of the annotation), size information describing the extents of the particular annotation with respect to the image of asset 701, and location information indicating the location of the particular annotation with respect to the image of asset 701. Based on such size and location information metadata associated with the particular annotation, rendering engine 430 can cause the particular annotation to be displayed on display screen 420 superimposed on asset 701 and in the correct position and at the correct relative size with respect to asset 701. In so doing, rendering engine translates the location of the particular annotation with respect to the image of asset 701 into a location of the particular annotation with respect to the asset 701 and scales the size of the particular annotation based on the size information associated annotation and the size of the asset 701.

Furthermore, in some embodiments, size and position of the annotation relative to common workspace 710 can be determined based on the information and metadata included in the above-described annotation input. Thus, other clients of collaboration system 200 can display the particular annotation superimposed on asset 701 with the correct position in common workspace 710 and with the correct relative size to common workspace 710. The forgoing is true even though focus mode has been triggered for asset 701 at user device 400, and the particular annotation is made by a user at user device 400. In such embodiments, rendering engine 430 may translate the information and metadata included in the above-described annotation input into a correct position in common workspace 710 and a correct size relative to common workspace 710. Alternatively or additionally, in such embodiments, the collaboration server 490 or the other clients of collaboration system 200 may translate the information and metadata included in the above-described annotation input into the correct position in common workspace 710 and the correct size relative to the workspace. In either case, the particular annotation performed at user device 400 on asset 701 (for which focus mode has been triggered) can be displayed with correct size and location in common workspace 710 by the other clients of collaboration system 200.

In sum, embodiments of the present invention provide techniques for changing the presentation of a selected asset at a local display system without the presentation changes being mirrored at other collaboration locations. To prevent presentation changes made locally to be mirrored at other display systems in the collaboration system, presentation metadata associated with the selected asset are not included in notifications broadcast across a messaging infrastructure of the collaboration system.

At least one advantage of the techniques described herein is that, when a local display system is a hand-held or other computing device with a small display screen, an asset can be expanded to fill most or all of the display screen of the display system without affecting the size or location of the asset as displayed by remote display systems.

1. In some embodiments, a method for displaying content during a collaboration session comprises: causing an asset to be displayed on a first display at a first size and at a first aspect ratio, while the asset is displayed on a second display at a second size and at the first aspect ratio; receiving a first display input via the first display indicating a mode change for displaying the asset; in response to receiving the first display input, causing an image of at least a portion of the asset to be displayed on the first display at a third size that is larger than the first size, while the asset continues to be displayed on the second display at the second size and at the first aspect ratio.

2. The method of clause 1, wherein causing the image of the at least a portion of the asset to be displayed on the first display comprises scaling the image to fit one of a maximum horizontal display dimension associated with the first display and a maximum vertical display dimension associated with the first display.

3. The method of clauses 1 or 2, further comprising causing a portion of a collaboration workspace that includes the asset to be displayed on the first display, while simultaneously causing the image of the at least a portion of the asset to be displayed on the first display.

4. The method of any of clauses 1-3, further comprising blurring or otherwise obscuring the portion of the collaboration workspace displayed on the first display.

5. The method of any of clauses 1-4, wherein causing the portion of the digital collaboration workspace to be displayed comprises displaying at least a portion of the asset.

6. The method of any of clauses 1-5, wherein the at least a portion of the asset is displayed at the first aspect ratio.

7. The method of any of clauses 1-6, further comprising: receiving a second display input via the first display indicating a size change for displaying the asset; in response to receiving the second display input indicating the size change, causing the image of the at least a portion of the asset to be displayed on the first display at a fourth size; and causing the image of the at least a portion of the asset to be displayed at the fourth size on the first display while the asset is simultaneously displayed on the second display at the second size and at the first aspect ratio.

8. The method of any of clauses 1-7, further comprising: while the asset is displayed on the second display at a current location, receiving via the first display a second display input indicating a position change for the asset; in response to receiving the second display input, causing the image of the at least a portion of the asset to stop being displayed at a first location on the first display; and while the asset is displayed on the second display at the current location, causing the image of the at least a portion of the asset to be displayed at a second location on the first display.

9. The method of any of clauses 1-8, wherein causing the at least a portion of the image of the asset to be displayed on the first display comprises retrieving image data associated with the asset.

10. The method of any of clauses 1-9, further comprising, while causing the image of the at least a portion of the asset to be displayed on the first display at the third size: receiving via the first display an annotation input for the asset; and transmitting the annotation input to computing device corresponding to the second display via a content server.

11. The method of any of clauses 1-10, wherein the first display comprises a gesture-sensitive display surface and the second display comprises a gesture-sensitive display surface.

12. The method of any of clauses 1-11, further comprising, in response to receiving the first display input, sending no size or location data associated with the asset to a content server for which a computing device corresponding to the second display is a client.

13. In some embodiments, a non-transitory computer readable medium storing instructions that, when executed by a processor, cause the processor to perform the steps of: causing an asset to be displayed on a first display at a first size and at a first aspect ratio, while the asset is displayed on a second display at a second size and at the first aspect ratio, receiving a first display input via the first display indicating a mode change for displaying the asset; in response to receiving the first display input, causing an image of at least a portion of the asset to be displayed on the first display at a third size that is larger than the first size, while the asset continues to be displayed on the second display at the second size and at the first aspect ratio.

14. The non-transitory computer readable medium of clause 13, wherein causing the image of the at least a portion of the asset to be displayed on the first display comprises scaling the image to fit one of a maximum horizontal display dimension associated with the first display and a maximum vertical display dimension associated with the first display.

15. The non-transitory computer readable medium of clauses 13 or 14, further comprising causing a portion of a collaboration workspace that includes the asset to be displayed on the first display, while simultaneously causing the image of the at least a portion of the asset to be displayed on the first display.

16. The non-transitory computer readable medium of any of clauses 13-15, further comprising blurring or otherwise obscuring the portion of the collaboration workspace displayed on the first display.

17. The non-transitory computer readable medium of any of clauses 13-16, wherein causing the portion of the digital collaboration workspace to be displayed comprises displaying at least a portion of the asset.

18. The non-transitory computer readable medium of any of clauses 13-17, wherein the at least a portion of the asset is displayed at the first aspect ratio.

19. The non-transitory computer readable medium of any of clauses 13-18, further comprising: receiving a second display input via the first display indicating a size change for displaying the asset; in response to receiving the second display input indicating the size change, causing the image of the at least a portion of the asset to be displayed on the first display at a fourth size; and causing the image of the at least a portion of the asset to be displayed at the fourth size on the first display while the asset is simultaneously displayed on the second display at the second size and at the first aspect ratio.

20. In some embodiments, a system for displaying content during a collaboration session comprises: a memory storing a rendering engine and/or a focus mode module; and one or more processors that are coupled to the memory and, when executing the rendering engine and/or a focus mode module, are configured to: cause an asset to be displayed on a first display at a first size and at a first aspect ratio, while the asset is displayed on a second display at a second size and at the first aspect ratio, receive a first display input via the first display indicating a mode change for displaying the asset; in response to receiving the first display input, cause an image of at least a portion of the asset to be displayed on the first display at a third size that is larger than the first size, while the asset continues to be displayed on the second display at the second size and at the first aspect ratio.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for displaying content during a collaboration session, the method comprising:
causing an asset to be displayed on a first display at a first size and at a first aspect ratio, while the asset is displayed on a second display at a second size and at the first aspect ratio,
receiving a first display input via the first display indicating a mode change for displaying the asset;
in response to receiving the first display input, causing an image of at least a portion of the asset to be displayed on the first display at a third size that is larger than the first size, while the asset continues to be displayed on the second display at the second size and at the first aspect ratio.

2. The method of claim 1, wherein causing the image of the at least a portion of the asset to be displayed on the first display comprises scaling the image to fit one of a maximum horizontal display dimension associated with the first display and a maximum vertical display dimension associated with the first display.

3. The method of claim 1, further comprising causing a portion of a collaboration workspace that includes the asset to be displayed on the first display, while simultaneously causing the image of the at least a portion of the asset to be displayed on the first display.

4. The method of claim 3, further comprising blurring or otherwise obscuring the portion of the collaboration workspace displayed on the first display.

5. The method of claim 3, wherein causing the portion of the digital collaboration workspace to be displayed comprises displaying at least a portion of the asset.

6. The method of claim 5, wherein the at least a portion of the asset is displayed at the first aspect ratio.

7. The method of claim 1, further comprising:
receiving a second display input via the first display indicating a size change for displaying the asset;
in response to receiving the second display input indicating the size change, causing the image of the at least a portion of the asset to be displayed on the first display at a fourth size; and
causing the image of the at least a portion of the asset to be displayed at the fourth size on the first display while the asset is simultaneously displayed on the second display at the second size and at the first aspect ratio.

8. The method of claim 1, further comprising:
while the asset is displayed on the second display at a current location, receiving via the first display a second display input indicating a position change for the asset;
in response to receiving the second display input, causing the image of the at least a portion of the asset to stop being displayed at a first location on the first display; and
while the asset is displayed on the second display at the current location, causing the image of the at least a portion of the asset to be displayed at a second location on the first display.

9. The method of claim 1, wherein causing the at least a portion of the image of the asset to be displayed on the first display comprises retrieving image data associated with the asset.

10. The method of claim 1, further comprising, while causing the image of the at least a portion of the asset to be displayed on the first display at the third size:
receiving via the first display an annotation input for the asset; and
transmitting the annotation input to computing device corresponding to the second display via a content server.

11. The method of claim 1, wherein the first display comprises a gesture-sensitive display surface and the second display comprises a gesture-sensitive display surface.

12. The method of claim 1, further comprising, in response to receiving the first display input, sending no size or location data associated with the asset to a content server for which a computing device corresponding to the second display is a client.

13. A non-transitory computer readable medium storing instructions that, when executed by a processor, cause the processor to perform the steps of:
causing an asset to be displayed on a first display at a first size and at a first aspect ratio, while the asset is displayed on a second display at a second size and at the first aspect ratio,
receiving a first display input via the first display indicating a mode change for displaying the asset;
in response to receiving the first display input, causing an image of at least a portion of the asset to be displayed on the first display at a third size that is larger than the first size, while the asset continues to be displayed on the second display at the second size and at the first aspect ratio.

14. The non-transitory computer readable medium of claim 13, wherein causing the image of the at least a portion of the asset to be displayed on the first display comprises scaling the image to fit one of a maximum horizontal display dimension associated with the first display and a maximum vertical display dimension associated with the first display.

15. The non-transitory computer readable medium of claim 13, further comprising causing a portion of a collaboration workspace that includes the asset to be displayed on the first display, while simultaneously causing the image of the at least a portion of the asset to be displayed on the first display.

16. The non-transitory computer readable medium of claim 15, further comprising blurring or otherwise obscuring the portion of the collaboration workspace displayed on the first display.

17. The non-transitory computer readable medium of claim 15, wherein causing the portion of the digital collaboration workspace to be displayed comprises displaying at least a portion of the asset.

18. The non-transitory computer readable medium of claim 17, wherein the at least a portion of the asset is displayed at the first aspect ratio.

19. The non-transitory computer readable medium of claim 13, further comprising:
receiving a second display input via the first display indicating a size change for displaying the asset;
in response to receiving the second display input indicating the size change, causing the image of the at least a portion of the asset to be displayed on the first display at a fourth size; and
causing the image of the at least a portion of the asset to be displayed at the fourth size on the first display while the asset is simultaneously displayed on the second display at the second size and at the first aspect ratio.

20. A system for displaying content during a collaboration session, the system comprising:
a memory storing a rendering engine and/or a focus mode module; and
one or more processors that are coupled to the memory and, when executing the rendering engine and/or a focus mode module, are configured to:
cause an asset to be displayed on a first display at a first size and at a first aspect ratio, while the asset is displayed on a second display at a second size and at the first aspect ratio,
receive a first display input via the first display indicating a mode change for displaying the asset;
in response to receiving the first display input, cause an image of at least a portion of the asset to be displayed on the first display at a third size that is larger than the first size, while the asset continues to be displayed on the second display at the second size and at the first aspect ratio.
